(19) United States
(12) Patent Application Publication
(10) Pub. No.: US 2012/0187670 A1
(43) Pub. Date: Jul. 26, 2012

(54) SUSPENSION SYSTEM

(75) Inventors: Joao Felipe de Souza Araujo, Caxias do Sul (BR); Remi Pizzeta, Caxias do Sul (BR); Rodrigo de Oliveira dos Reis, Caxias do Sul (BR); Gabriel Radaelli Piazza, Farroupilha (BR)

(73) Assignee: SUSPENSYS SISTEMAS AUTOMOTIVOS LTDA., Caxias do Sul (BR)

(21) Appl. No.: 13/189,292

(22) Filed: Jul. 22, 2011

(30) Foreign Application Priority Data
Jul. 22, 2010 (BR) MU 9001209-7

(51) Int. Cl. B62D 21/11

(52) U.S. Cl. 280/788

(57) ABSTRACT

A modular structure applied to rear suspensions for commercial vehicles, especially designed to be used in a family of suspensions, said structure comprising a crossbeam (1) attached perpendicularly to the frame, fixing bearings (2) of the upper reaction rods of the suspension to the frame, and central brackets (3).

### FIELD OF THE INVENTION

The present invention relates to a modular structure applied to rear suspensions for commercial vehicles.

### RELATED APPLICATIONS

This application claims priority to Brazilian Utility Model Application No. MU 9001209-7, filed Jul. 22, 2010.

### BACKGROUND

There is currently a large variety of rear suspension models for trucks on the market, and some examples are shown in FIGS. 3, 6 and 9, where the manufacturers use solutions to improve each particular model, generating a great variety and diversity of components, generally specific and focused on each model proposed, in detriment to standardization.

For a certain manufacturer, in particular one who produces few models, perhaps standardization in the sense of allowing the use of the components of a certain suspension on several others, does not represent significant gains to the extent of justifying a redrafting of the several designs of existing suspensions. However, certainly for manufacturers who produce a variety of models and on an industrial scale, a standardized suspension structure may represent significant gains, thus assuring the feasibility of the modulation proposed by reformulating its designs.

Suspensions known in the state of the art were idealized without focusing on standardization, or interchangeability of parts, possibly because they were conceptualized and developed at different times and by different companies. This situation may be reversed when the focus is to develop a new family of suspensions within a same company, taking advantage of the moment and favoring this condition, which should be explored to the greatest extent possible during the conceptualization phase.

Patent document U.S. Pat. No. 6,527,286 B2 shows an example of rear air suspension for trucks, and describes a concept of articulating beams of the axles of the suspension between the upper and lower part, replacing the traditional system of reaction rods as shown, by a structural box system which plays a double role, articulation and stabilizing effect on side rolling.

The suspension described above mentions the advantage of obtaining a reduction in the variety and quantity of components and their complexity, as well as weight and cost, and manufacturing it requires the use of technologies and complex processes with high costs.

The document above also cites that said system can be adapted to other suspension models, not with the objective of standardization, but merely to substitute other parts, not demonstrating the idea of modulation.

Document PI 9814085-0 describes a two-axle vehicle suspension arrangement comprising a pair of arms that support the air springs at each end of the arms, these being joined to a vehicle frame, characterized wherein the arms are fixed to the axles in an asymmetrical and inverted position, such that the springs nearest each axle are aligned and close, forming a system statically in equilibrium of forces, which result from the product of the force of each spring by its lever arm by virtue of the asymmetrical position thereof.

The suspension described above mentions as the main benefit, helping the assembly of other components of the vehicle, due to the reduction in the distance between the air spring and the axle, a condition which led to new and specific components for the solution proposed, thus being contrary to the idea of standardization. Additionally, there was a need to create new sizes of air spring and arms, which likely cannot be used in other suspension models.

Document PI9104869A refers to a new anchoring concept between axles and longitudinal spring of a bogie suspension, by attachment with elastomer and connection artifices where the main objectives are to eliminate the upper reaction rods and the wear blocks between the axle and spring couplings to achieve a reduction in weight and wear on items for replacement.

In said document, it can be noted that the innovation directly benefits the model in question, without focusing on standardization, being contrary to the objective of the present model.

Although the document cites various advantages, in practice said innovations are scantly present in the suspensions in use in the state of the art, perhaps due to their complexity and high cost.

Therefore, there is a need in the state of the art to provide a modular structure applied to rear suspensions for commercial vehicles, built to be used in a family of suspensions, with the objective of providing a standardization and reduction in the quantity and the diversity of components, and to improve conditions of industrial manufacturing, logistics, transport and assembly on the vehicle, resulting in a reduction in consumption of materials and manpower in general.

This new modular suspension structure comprises the use of bearings, crossbeam and central bracket, standardized and interchangeable, which can be adapted to other families of suspensions of the state of the art.

### SUMMARY OF THE INVENTION

Various exemplary embodiments of the present invention relate to a modular structure applied to rear suspensions for commercial vehicles, especially designed to be used in a family of vehicles suspensions, with the objective of achieving a standardization, providing a reduction in the quantity and the diversity of components, and an improvement in the conditions of industrial manufacturing, logistics, transport and assembly on the vehicle, the result being a reduction in consumption of materials and manpower in general.

The modular structure applied to rear suspensions for commercial vehicles is characterized by comprising a crossbeam, bearings and central supports, specially designed to be interchangeable between several suspensions of a family, this being possible because the articulating pivot of one of the suspensions is located on the spring.

An objective of the present invention is to provide a modular structure applied to rear suspensions for commercial vehicles, whose structure is designed to be used in a family of suspensions in vehicles, so as to obtain a standardization, viewing a reduction in the quantity and the diversity of components, and to improve conditions of industrial manufacturing, logistics, transport and assembly on the vehicle.

Another objective is to create new arrangements between the components involved in the interfaces with the frame and axles of the vehicle based on the modular structure, to enable their use in several arrangements of the modulation.

### DESCRIPTION OF THE DRAWINGS

FIG. 1—Perspective view of the modular structure according to an exemplary embodiment of the present invention applied to rear suspensions with two bogie-type axles, for highway use in commercial vehicles;

FIG. 2—Perspective view of the modular structure according to an exemplary embodiment of the present invention applied to rear suspensions with two bogie-type axles, for heavy duty use in commercial vehicles;

FIG. 3—Perspective view of a conventional suspension having two axles of the bogie type for commercial vehicles;

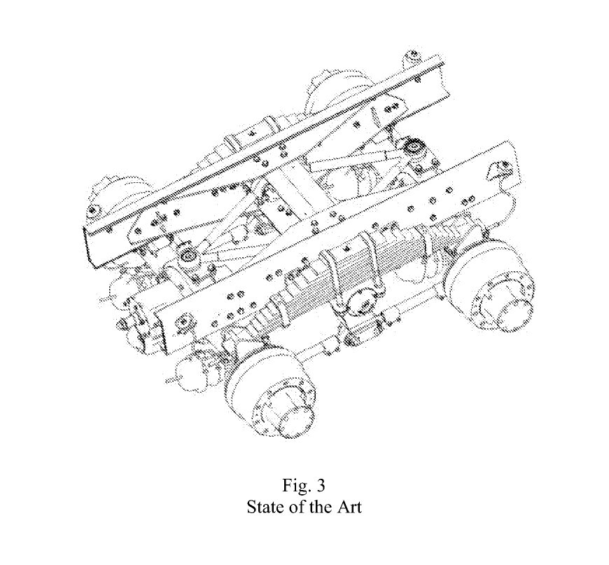

FIG. 4—Perspective view of the modular structure according to an exemplary embodiment of the present invention applied to rear suspensions of the air type with two axles and eight air springs for commercial vehicles;

FIG. 5—Perspective view of the modular structure according to an exemplary embodiment of the present invention applied to rear suspensions with two axles and with four air springs for commercial vehicles;

FIG. 6—Perspective partial view of a conventional air suspension having two axles with eight springs;

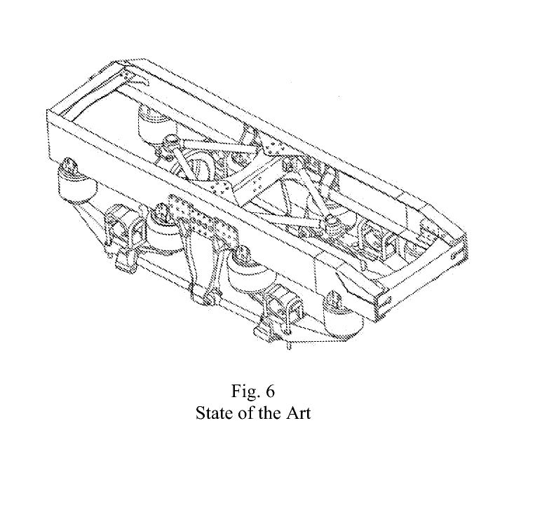

FIG. 7—Perspective view of the modular structure according to an exemplary embodiment of the present invention applied to rear suspensions having one axle and with four air springs for commercial vehicles;

FIG. 8—Perspective view of the modular structure according to an exemplary embodiment of the present invention applied to rear suspensions having one axle with two air springs for commercial vehicles;

FIG. 9—Side view of a conventional model of air suspension having one axle with two air springs for commercial vehicles;

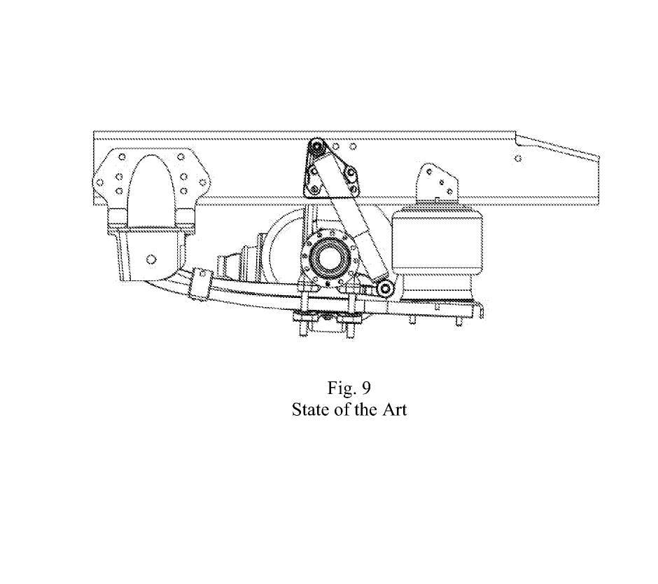

FIG. 10—Perspective view of the modular structure according to an exemplary embodiment of the present invention applied to rear suspensions having two axles of the bogie type, illustrating the bearing in detail;

FIG. 11—Perspective view of the modular structure according to an exemplary embodiment of the present invention applied to rear suspensions having two axles of the air type, illustrating the bearing in detail.

### DETAILED DESCRIPTION OF PREFERRED EMBODIMENTS

As illustrated in the accompanying drawings, the modular structure according to various exemplary embodiments of the present invention may be applied to rear suspensions for commercial vehicles and may constitute a modular structure used in several models of rear suspensions, said structure comprising a crossbeam (1) attached perpendicularly to the frame, fixing bearings (2) of the upper reaction rods of the suspension to the frame, central brackets (3) also being provided.

Said crossbeam (1) is comprised of a body formed by two “C” type profiles, assembled upside down and joined by rivets or screws to the rims of the profiles of the headboards (i.e., the front members of the suspension), and the external rims of said “C” type profiles present a biconcave side projection, allowing said bearings (2) to remain internally imbedded and fastened to the core of the frame. This structure jointly with bearings is geometrically designed for the function of housing the upper reaction rods (6) of the suspension and the central brackets (3) outside the frame, forming a modular structure that serves to connect the other suspension components, meaning it can be used in all the suspensions described.

Said bearings (2) are internally attached to the core of the stringers, and pass over the profiles of the body of the crossbeam longitudinally to the frame, forming a single part on each side of the frame, so as to transmit the forces coming from the upper reaction rods (6) directly to the stringers.

Said modular structure also comprises central brackets (3) attached by the upper part outside the frame, which house the reaction rods (5) in their inner part, to transmit the forces of the suspension directly to the core of the frame, a condition which considerably improves the performance of these components in relation to the state of the art.

According to the present invention, said modular structure can be assembled and used in a family of suspensions, including the so-called bogie and air, with variants in relation to the state of the art regarding the use of the main components, be they attached to the frame or to the vehicle axles. Said components are designed to allow them to be used in the different models of suspensions and vehicles.

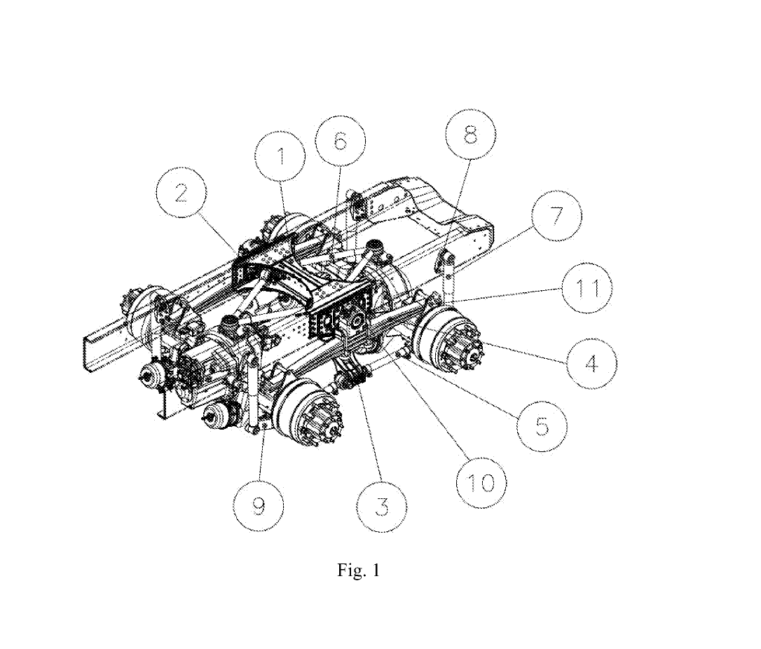

Said modular structure is geometrically designed so as to allow assemblability and interchangeability between the various models of suspensions presented, and also between the right and left side of the frame due to its symmetrical geometry in relation to the vertical plane that passes through the center line of the articulating pivot shown in FIG. 1 and perpendicular to the vehicle frame.

FIG. 1 illustrates the modular structure applied to a rear suspension of the bogie type having two tandem axles for highway use, said suspension is also comprised of various components such as leaf spring (4), lower reaction rods (5), upper reaction rods (6), shock absorbers (7), upper supports of the shock absorbers (8), lower brackets of the shock absorbers (9), pivoting bearing (10), and spring guides (11), which are mostly part of the other suspension models described herein.

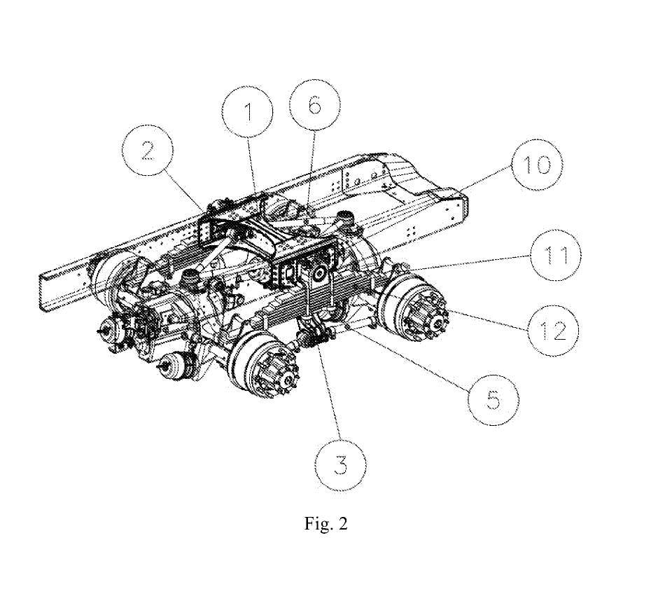

FIG. 2 shows the modular structure applied to the same type of rear suspension of FIG. 1, but for heavy duty application, where the components shown in FIG. 1 are mostly used, with the exception of the leaf spring (12) which are suited to said application.

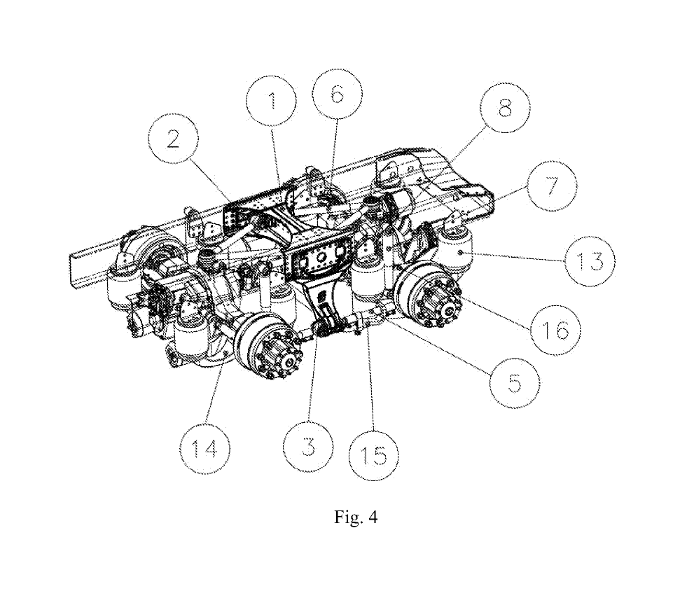

FIG. 4 shows the modular structure applied to a rear suspension having two tandem axles with eight air springs (13), which also mostly use the components shown in FIG. 1. In this case, the hanging components of the air springs (14), stabilizing beam (15) and torque plate (16) were incorporated, which are also part of other suspension arrangements described below.

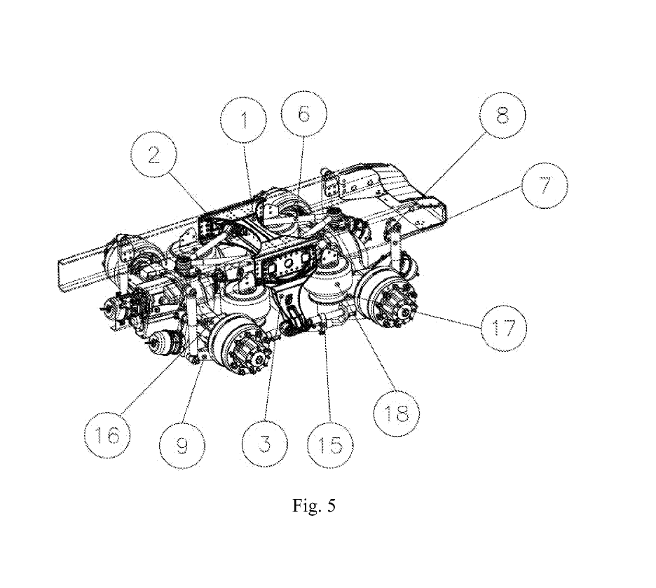

FIG. 5 illustrates the modular structure applied to a rear suspension having two tandem axles with four air springs, which includes a support (17) of the air spring (18), which also mostly uses the components shown in FIG. 1 and others of FIG. 4.

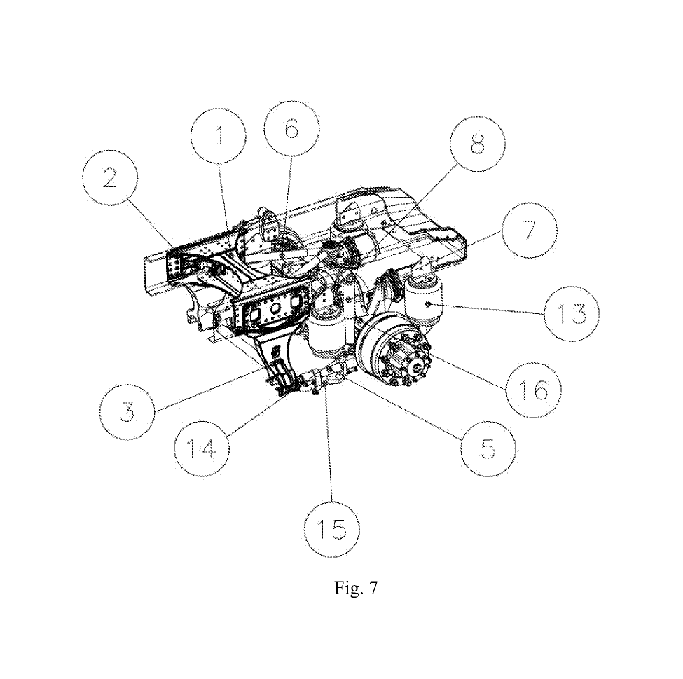

FIG. 7 shows the modular structure applied to a rear suspension having one axle with four air springs (13), which also mostly uses the components shown in FIG. 1, as well as others of FIG. 4.

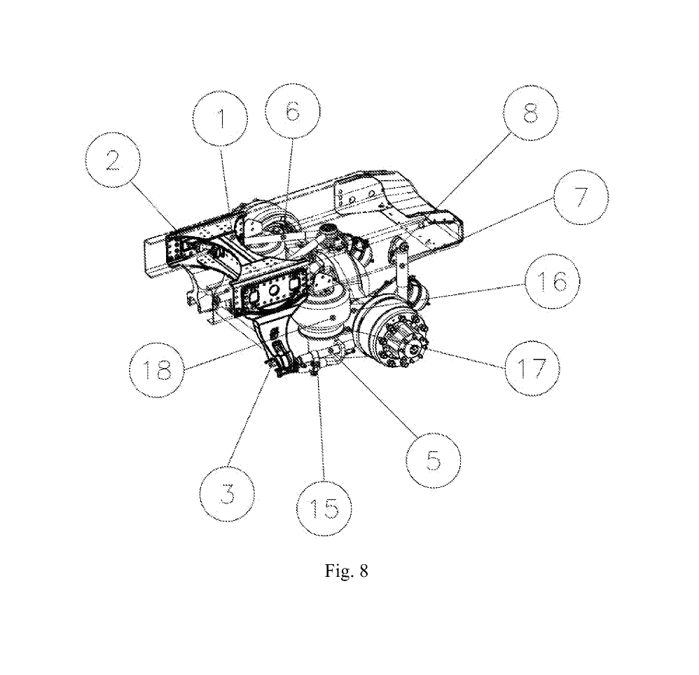

FIG. 8 shows the modular structure applied to a rear suspension having one axle with two air springs (18), which also mostly uses the components shown in FIG. 1 and others of FIG. 5.

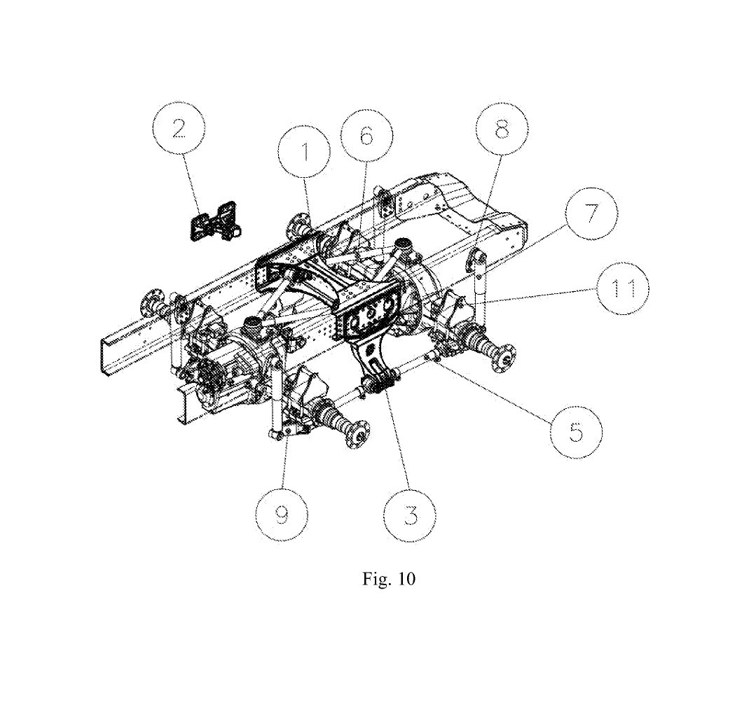

FIG. 10 is a reproduction of FIG. 1 showing preferably the components that are interchangeable with the other suspensions, with detailed illustration of the bearing (2) of the modular structure of an exemplary embodiment of the present invention.

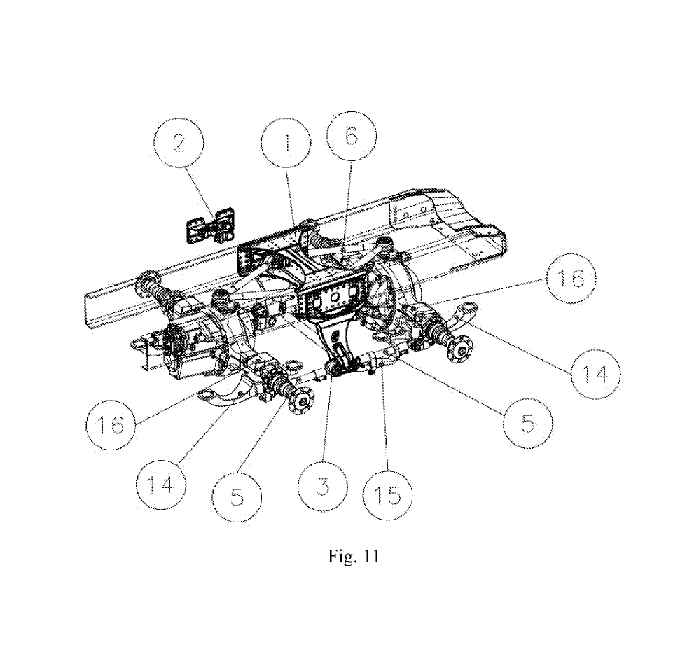

FIG. 11 is a reproduction of FIG. 4 showing preferably the components that are interchangeable with the other suspensions, in addition to others that are part of the family of air suspensions, with detailed illustration of the bearing (2) of the modular structure of an exemplary embodiment of the present invention.

In practice, the modular structure applied to rear suspensions for commercial vehicles provides a significant reduction in overall expenses, due to standardization, obtaining a reduction in the quantity and the diversity of components, improving the conditions of industrial manufacturing, logistics, transport and assembly on the vehicle.

Persons skilled in the art will easily understand how changes can be made in the present model without straying from the concepts set forth in the description above. These changes shall be deemed to be included within the scope claimed in the present application. Consequently, the particular embodiments previously described in detail are merely illustrative and not limitative in terms of the scope of the present invention, to which the full extent of the accompanying claims should be given, in addition to all and any equivalents thereof.

1. A modular structure applied to rear suspensions for commercial vehicles, the rear suspensions comprising a frame, upper reaction rods, two front members and stringers, the modular structure comprising:
a crossbeam attached perpendicularly to the frame and comprised of a body formed by two “C” type profiles, assembled upside down and joined to rims of the profiles of the two front members, external rims of said “C” type profiles presenting a biconcave side projection;
bearings that attach the upper reaction rods of the suspension to the frame, said bearings disposed on each side of the frame, and being internally attached to a core of the stringers, jointly with the profile of the front members and passing over the core of a section of the body of the crossbeam; and
central brackets attached to the core of the body profile, on each side of the frame;
said modular structure being interchangeable in a family of suspensions.

2. The modular structure of claim 1, wherein the crossbeam is joined to the rims by rivets or screws.
